(19) United States
(12) Patent Application Publication
(10) Pub. No.: US 2015/0048075 A1
(43) Pub. Date: Feb. 19, 2015

(54) Curing System

(71) Applicants: Jose Pedrosa, Farnborough (GB); Daniel Johnson, Farnborough (GB); Richard Dixon, Farnborough (GB)

(72) Inventors: Jose Pedrosa, Farnborough (GB); Daniel Johnson, Farnborough (GB); Richard Dixon, Farnborough (GB)

(73) Assignee: INTRINSIQ MATERIALS LTD., Farnborough, Hampshire (GB)

(21) Appl. No.: 14/238,901

(22) PCT Filed: Aug. 16, 2012
(86) PCT No.: PCT/GB2012/052002

§ 371 Date: Nov. 3, 2014

(30) Foreign Application Priority Data
Aug. 16, 2011 (GB) 1114048.0

(51) Int. Cl. H05B 1/02

(52) U.S. Cl. CPC H05B 1/023
USPC 219/410

(57) ABSTRACT

Apparatus for curing of nanoparticle material, the apparatus comprising: a receptacle for receiving a substrate upon which a laser of the nanoparticle ink has been placed; and a laser bar diode array comprising a first bar diode laser, the array configured to emit a laser as a continuous wave and to cure the deposited nanoparticle material.

### TECHNICAL FIELD

The present invention relates to apparatus for curing nanoparticles. In particular to a system which uses diode bar lasers to cure nanoparticles.

### BACKGROUND TO THE INVENTION

It is known to cure or sinter nanoparticles to produce large scale structures from nanoparticles. An advantage of curing nanoparticles is that the temperatures involved for curing nanoparticles is significantly lower than for the bulk curing of larger particles of the same material.

Known, commercially available, systems for curing nanoparticles typically involve the use of convection ovens or Xenon flash lamp based systems. In such systems the Xenon lamps emit pulsed light which is directed onto films of nanoparticles to be cured. The light emitted by the lamps is of sufficient energy to cure the nanoparticles.

Such prior art systems however suffer from a number of deficiencies. For example, due to the natural spread in wavelengths of the emitted light source from the Xenon lamp, contributions from non-peak energy wavelengths can result in unwanted effects. For example, the spread in wavelength may result in limited penetration of the light into thicker films or sealing top surface layers trapping unwanted organic species in the remaining structure. This occurs because light from the higher frequency, and therefore higher energy, from the tail of the energy distribution is readily absorbed in the near surface region sintering this region. Accordingly, the binder or organic suspension in which nanoparticles are typically held is only partially removed, limiting the conductivity. The non-symmetrical distribution of intensity of energy also produces energy which is not used in the process of sintering and accordingly reduces the efficiency of the curing. This can also heat and damage the substrate used.

The pulsing effect of the lamp, or indeed other light sources, furthermore tends to create high energy peaks which are found to ablate films rather than cause the sintering process. Accordingly, the structure of the cured product may not have the desired structure.

The prior art also suffers from limitations on the number of substrates that can be used, particularly high thermal conductivity materials such as aluminium, silicon and ceramics, as the heat is conducted away from the area of incident light before sintering can take place. High thermal mass materials are routinely used in applications such as LED systems as part of efficient heat sink systems. Furthermore, some of the wavelengths of the lamps are known to cause damage to certain substrates, due to these wavelengths of light being readily absorbed by the substrate and causing heat damage. This is known to occur with polymeric and ITO films, and therefore affects the suitability of the curing method for certain materials.

To overcome at least some of the problems detailed above there is provided a curing apparatus which comprises an array of one or more diode bar lasers, preferably arranged in series, which emits a continuous or quasi-continuous beam to cure the nanoparticles. Each diode bar laser contains a one-dimensional array of broad area emitters, arranged so that the laser beam emitted, or laser ‘curtain’, is configured to extend across the width of a substrate allowing it to cure large surface areas of material very rapidly.

In the present specification the size of the particle is used to refer to the diameter of the particle. The term continuous wave, as is accepted in the art, refers to a laser beam that is produced as a continuous output beam i.e., a beam that is not pulsed. Such beams are steady-state beams and typically have a constant amplitude and frequency. Quasi-continuous lasers, as is accepted in the art, refer to laser beams that are pulsed, but emit—during the emission phase—a laser that has a continuous output i.e., at a constant amplitude and frequency. Such quasi-continuous beams are only switched on for a certain time period, which is long enough for the laser to emit at a steady state (i.e., constant amplitude and frequency). Therefore, a steady state beam is taken to refer to lasers which have a constant amplitude and frequency, such as continuous and quasi-continuous beams.

Advantageously the apparatus allows for a high level of control of the curing diode bar laser which helps maintain the efficiency in the curing process. It is found that, due to the uniform nature of the curing beam, the invention also allows for a better penetration of the material being cured with the array helping to ensure that lower layers of deposited films of nanoparticles are cured. Advantageously, as the array uses monochromatic diode bar lasers, the curing light does not have a higher energy tail as found in prior art systems to cause many of the aforementioned problems.

A further benefit of the invention is that it is found to remove a higher proportion of organic binder/solvent which is present in the deposited nanomaterials. As the present invention allows for a greater control of the light used to cure the materials, in terms of wavelength/energy and energy distribution, the curing laser beam used can be adapted to ensure removal of organic binders/solvents.

According to an aspect of the invention there is provided apparatus for curing of nanoparticle material, the apparatus comprising: a receptacle for receiving a substrate upon which a layer of the nanoparticle ink has been placed; and a laser array comprising a first diode bar laser, the array configured to emit a laser beam as a continuous or quasi-continuous wave and to cure the deposited nanoparticle material.

Optionally, wherein the laser extends the width of the deposited nanoparticle ink layer. Optionally, wherein the apparatus further comprises an optical array placeable between the laser array and substrate and configured to modify the wavefront emitted by the laser array. Preferably, wherein the optical array is configured to focus or diffuse the emitted laser beam. Preferably, wherein the optical array comprises a first aperture configured to produce a uniform wavefront.

Optionally, wherein the optical array comprises a first lens. Optionally, further comprising one or more further diode lasers. Preferably, wherein the plurality of diode lasers are placed in series. Preferably, wherein two or more of the lasers are configured to emit at different frequencies. Preferably, wherein a second laser is configured to dry the deposited material. Optionally, further comprising a processor configured to control the apparatus. Preferably, wherein the processor is part of a controller unit configured to selectively engage the one or more lasers. Preferably, wherein the processor is configured to control the intensity of the emitted lasers. Preferably, wherein the controller further controls the current supplied to the laser array. Optionally, further comprising a sensor configured to measure the temperature of the apparatus. Preferably, wherein the sensor is in communication with the processor and the processor is further configured to maintain the temperature below a predetermined value by selectively adjusting the intensity of the laser. Optionally, further comprising a computer configured to receive information regarding the deposited material and/or substrate. Preferably, wherein the computer is further configured to determine the relative separation between the receptacle, optical array and laser based on the received information.

Optionally, wherein the receptacle and laser array are moveable relative to each other. Optionally, further comprising a heat sink. The sample holder or receptacle is also required to hold the substrate flat; this can be achieved via use of a vacuum bed. The bed can be designed such that it is water cooled to ensure the substrate is maintained at a constant temperature during processing so that the sintering is more uniform. Alternatively the substrate can be heated such that lower laser power is required to complete the sintering process. Optionally, wherein the laser array is configured to emit at a frequency which is transparent to the substrate. Optionally, further comprising a source of inert gas to provide an inert atmosphere in which the nanoparticles are cured. This can be done by ensuring the sintering laser chamber contains an inert or reducing atmosphere or by blowing inert gas such as argon across the substrate during sintering, this also aids in removing any organic material from the substrate. Optionally, further comprising one or more further laser bar diode arrays. Optionally, further comprising a chamber in which the receptacle is placed and configured to reduce or use reflections of the laser light. In the case of reflections the backscattered light may be used to help sinter the rear side of the substrate, for example when curing films on PET or other transparent films. Optionally, wherein the wavelength emitted by the laser diode is such that the substrate is transparent and no or minimal heating effects are caused by the direct impact of the laser on the substrate.

Optionally the apparatus further comprises a heating element for heating the substrate. Optionally, wherein the receptacle is a vacuum bed. Preferably wherein the vacuum bed is water cooled. Optionally in embodiments with multiple lasers wherein a first laser is configured to emit at a lower power than a second laser, the first laser thereby soft sintering the deposited nanoparticle ink.

Other aspects of the invention will be apparent from the appended claim set.

### BRIEF DESCRIPTION OF THE FIGURES

Embodiments of the invention are now described, by way of example only, with reference to the accompanying drawings in which:

FIG. 1 is a schematic representation of the apparatus used according to an aspect of the invention;

FIGS. 2a and 2b are a schematic representation of the laser array according to an aspect of the invention;

FIG. 3 is a schematic representation of a laser array comprising a plurality of lasers;

FIG. 4 is a flow chart of the process of curing a material according to an aspect of the invention; and

FIG. 5 is plot of a power distribution curve from a laser bar diode.

### DETAILED DESCRIPTION OF AN EMBODIMENT

According to an aspect of the invention there is provided an apparatus to cure nanoparticles. In particular for the bulk curing of nanoparticles. The processes described herein are suitable for scaling from a worktop implementation to an industrial implementation.

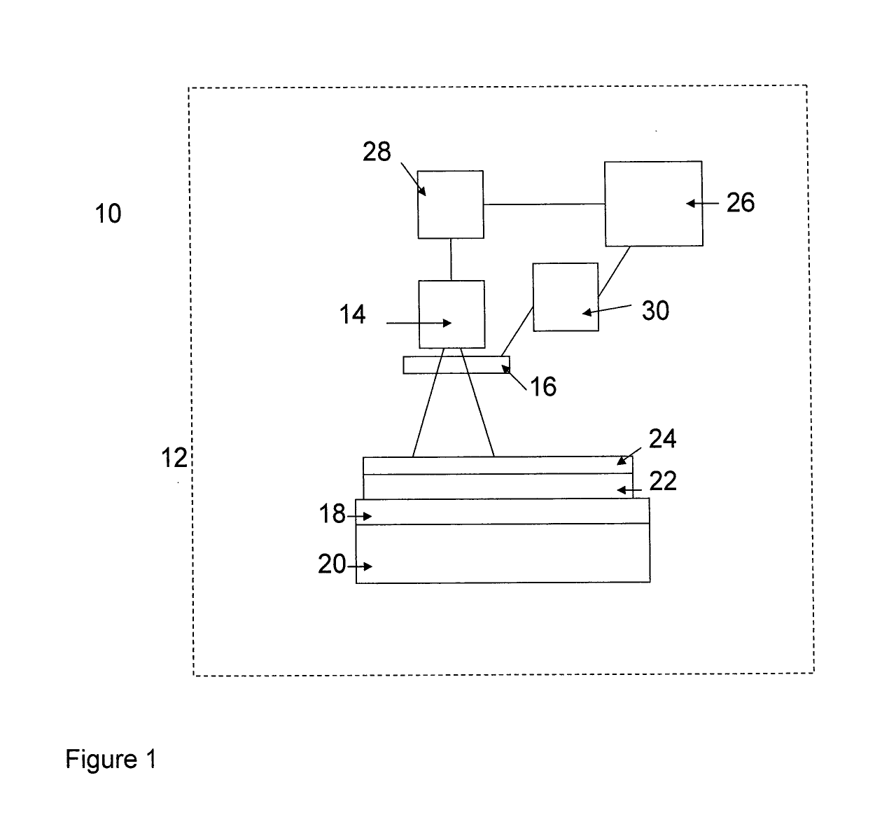

FIG. 1 shows a schematic representation of a curing apparatus 10. There is shown a chamber 12 in which the apparatus is held. The apparatus 10 comprises a diode bar laser array 14, which has an optical array 16 through which light from the diode bar laser array 14 passes onto a holder or receptacle 18, with a heat sink 20, upon which a substrate 22 is placed. The substrate 22 has a layer of nanoparticle ink 24 which is to be transformed (by sintering or curing). The apparatus is controlled by a computer 26 which controls the laser current supply 28 and an optics controller 30, it also receives inputs from a temperature sensor 32.

In a preferred embodiment the apparatus provides a chamber 12 in which the curing apparatus 10 is placed. The chamber 12 is coated with a paint which absorbs the light emitted from the laser array 14 and minimises reflections from the laser array 14. The chamber 12 also contains the apparatus in an inert atmosphere (i.e. in an atmosphere with a high concentration of inert gases) or a reducing atmosphere (i.e. an atmosphere in which oxygen and other oxidising gases are removed, such as 0-10% hydrogen in argon). The inert, or reducing, atmosphere advantageously ensures that the curing process results in the production of a film with minimal or zero oxide content, thereby increasing the purity of the production process. In other embodiments, to reduce costs, the chamber 12 may be omitted.

The diode bar laser array 14 is placed above receptacle 18 and is positioned so as to emit a laser beam onto the receptacle 18. The optical array 16 is positioned between the laser array 14 and the receptacle 18, so as to selectively vary the intensity of the emitted waveform by the laser array 14. The laser array 14 is powered by a current supply 28 which is controlled by a computer 26. The computer 26 is also enabled to select and place the appropriate optics in the optical array 16.

In use, the laser emitted by the laser array 14 cures the nanoparticles by sintering the individual particles so as to form a larger structure. Additionally, the laser has the effect of removing many organic compounds associated with the nanomaterial, thereby making a structure with a high purity. As the curing preferably occurs in a chamber 12 with an inert, or reducing, atmosphere, oxidisation of the formed structure is minimised.

In use, a substrate 22 coated in the nanomaterial 24 to be cured is placed on the receptacle 18. The substrate 22 is covered in nanoparticle material 24 via known methods such as printing. The nanoparticle material 24 may be a metal or semi-metal, such as copper, silver, silicon, nickel, tantalum, titanium, platinum, palladium, molybdenum, or aluminium. The nanoparticle material 24 is placed on a substrate 22, which may be a plastic such as polyimide (PI), polyethylene (PE), polypropylene (PP), Polyethylene terephthalate (PET), Polyethylene naphthalate (PEN), polycaronate (PC), or other suitable materials such as silicon nitride (SiN), Indium tin oxide (ITO), glass, Acrylonitrile butadiene styrene (ABS), ceramic, FR4, GX13, or paper.

The substrate 22 is placed on the receptacle 18, such as a curing table, though any suitable receptacle for holding the substrate 22 may be used. In the preferred embodiment the receptacle 18 and the laser array 14 are moveable relative to each other to allow for greater coverage. In a preferred embodiment the receptacle 18 is a table which can translate in the x-y plan, thereby increasing the coverage of the laser array 14. In a further embodiment the laser array 14 and receptacle 18 are fixed in relative positions and the beam emitted by the laser array 14 is controlled by the optical array 16 thereby allowing the beam emitted by the laser array 14 to cover the entire substrate 22 and therefore deposited nanomaterial 24.

The substrate 22 is illuminated by a beam from the diode bar laser array 14. The diode bar laser array 14 comprises one or more diode bar lasers. In embodiments with a plurality of diode bar lasers, the lasers are preferably placed in series. Diode bar lasers are commercially available and emit a beam which is essentially one dimensional extending several centimetres in a first axis (known as the slow axis) and a few millimetres in a second axis (known as the fast axis). The present invention takes advantage of the natural shape of the diode bar laser output to provide a beam that has a highly regular, rectangular shape. The diode bar lasers emit a continuous or quasi-continuous wave beam, that is to say a beam of constant amplitude and narrow spectrum. Thus the laser emits in a steady state. Therefore, unlike in Xenon systems there is no variation in the amplitude or frequency of the light source. In a preferred embodiment the laser emits at 808 nm, 915 nm, 938 nm, 975 nm or 976 nm, with a FWHM of <3 nm. However, other frequencies may be used and indeed depending on the material to be cured, and the substrate, the wavelength used is preferably different so as to ensure the optimal penetration and removal of organic species. Laser bar diodes operating in the range from 600 nm to greater than 2 μm can be used, with the higher laser wavelengths being suitable for curing thicker deposited layers.

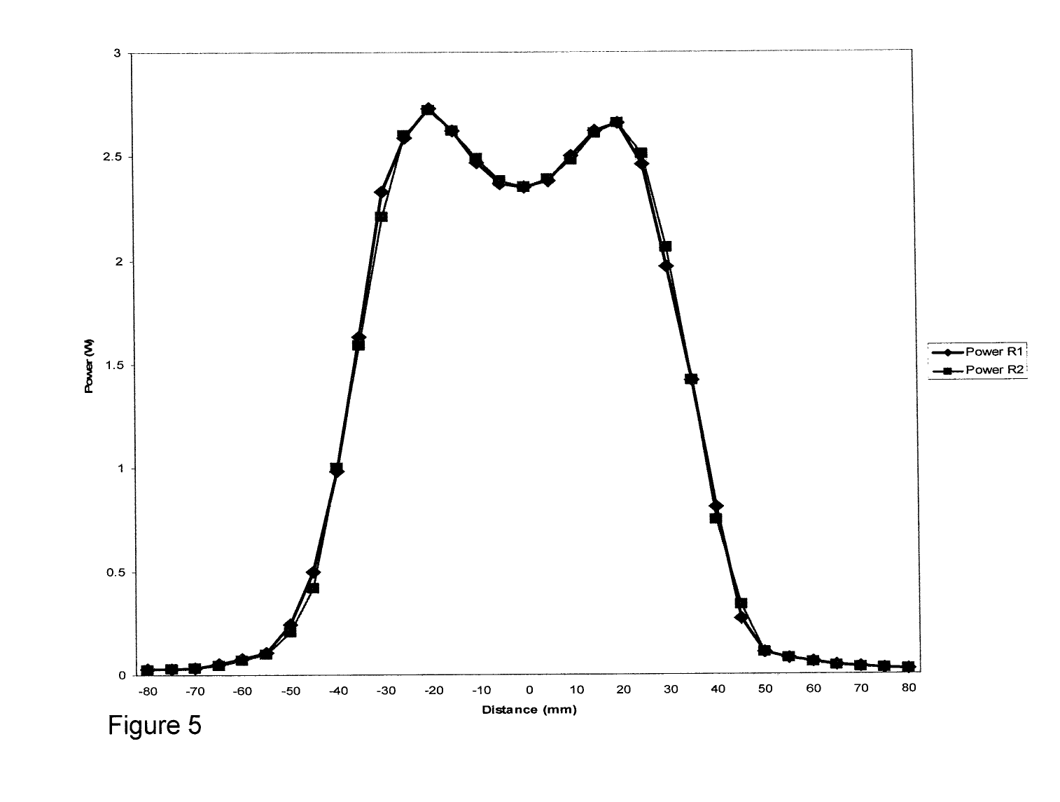

FIG. 5 shows the typical power distribution of a single laser bar diode. There is shown the power distribution for two runs R1 (shown as diamonds) and R2 (shown as squares).

As is shown in FIG. 5 laser bar diodes exhibit some non-uniformity due to temperature variations or differences in the semiconductor diodes across the bar. As shown in FIG. 5 the shape of the beam is constant across runs R1 and R2 and therefore the uniformity of the beam may be improved by use of several laser bar diode arrays positioned such that the emitted light overlaps. As the shape of each laser beam is known the laser bar diodes are positioned such that the overall effect is to average the emitted power and make the laser wavefront more uniform in intensity.

In embodiments of the invention which use multiple laser bar diodes in the laser array, the first laser may be operated at lower power/longer wavelength than one or more of the other laser bar diodes. The first laser therefore acts to drive off more organic content, thereby reducing or eliminating drying requirements. Furthermore, the use of the lower power first laser “soft” sinters the particles together densifying the structure and reducing mobility of the particles during the final sintering process stage (at higher power, with the other lasers). This helps to reduce effects such as Ostwald ripening where particles are sufficiently mobile to cause surface balling (lowering the overall surface energy). Equally the same laser may be used with the substrate passing multiple times through the laser curtain but with the laser bar diode bar power adjusted for each pass.

In other embodiments materials can be processed using alternative known drying methods, such as IR and UV lamps. Improved conductivity can be obtained by curing the metal in the ‘wet’ form which allows for greater mobility of the nanomaterials forming more dense structures and enabling higher conductivities to be achieved.

In a preferred embodiment an optical lens or array 16 is placed between the laser array 14 and the receptacle 18. The optical lens 16 is used to focus the beam onto the sample. Depending on the sample position relative to the focus position, the beam is of variable height (whilst maintaining a fixed width) allowing the energy density to be controlled. In an embodiment, a single lens whose length encompasses the output of the bar diode (which diverges), or several bar diodes in series, is used. For a given beam width, the working depth of the beam can be increased allowing greater tolerance on the substrate position relative to the laser array 14 by incorporating an additional lens to collimate the beam. In an embodiment the optical array 16 comprises a plurality of lenses, apertures, masks and gratings to provide a high level of control of the emitted laser beam.

The focussing of the beam is particularly useful for materials and substrates with high thermal conductivities that require a higher intensity beam to undergo structural changes via curing. By focussing the beam, the effective temperature of the beam can be raised allowing for curing of higher thermal conductivity material.

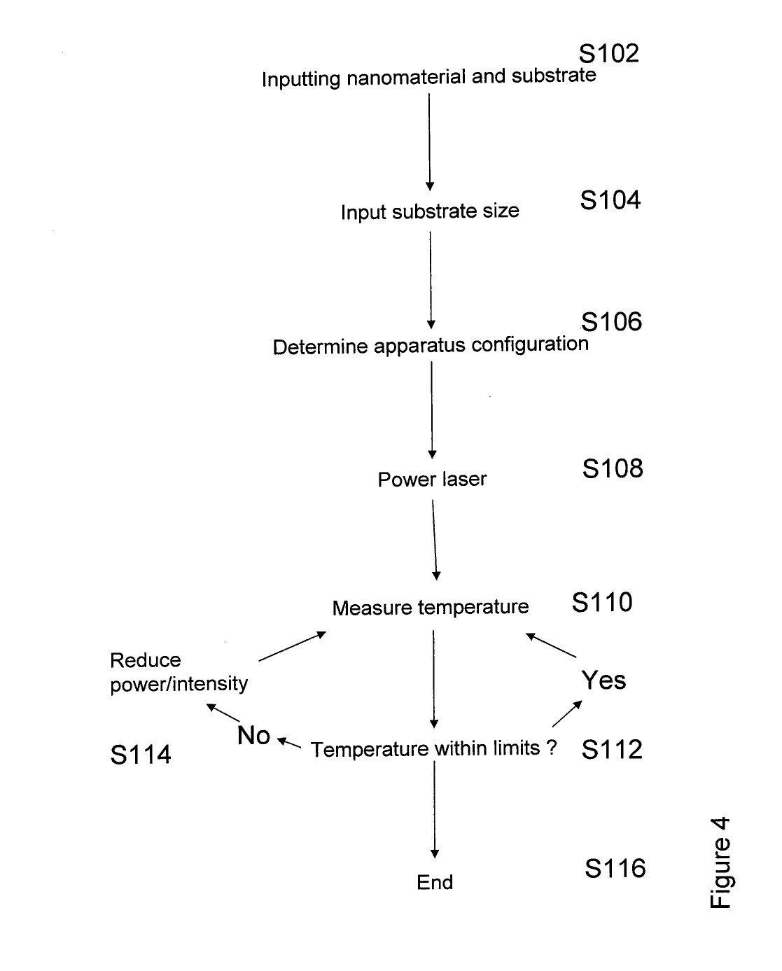

The form and functionality of the optical lens array is discussed in further detail with reference to FIG. 4.

In a further embodiment, the laser array 14 comprises a plurality of diode bar lasers of different wavelengths. As the interaction between the emitted laser light and a substance (deposited nanomaterial, substrate, etc) is governed by the energy of the emitted light photons, in an embodiment of the invention, there is provided a laser array 14 which comprises a plurality of diode bar lasers that emit at different wavelengths and therefore emit light photons of different energies. Depending on the nanomaterial 24 used and the substrate 22 material upon which the nanomaterial 24 is placed, the laser(s) selected by the computer 26 are optimally selected to ensure curing of the nanomaterial 24 whilst avoiding damage to the substrate 22 material. Optionally, if multiple nanomaterials 24 are deposited onto the substrate 22, and/or multiple substrates 22 are used, multiple lasers can be emitted by the laser array 14.

The optical array 16 further allows for the selection of a number of different lenses or masks depending on the desired waveform. In particular apertures or masks can be selected to produce a uniform waveform with a constant energy. The waveform advantageously enables a very fast transition from the uncured to cured state or from undried to a dried condition. The invention advantageously overcomes many of the problems associated with the broadband wavelength emission of a Xenon lamp. For example, the present invention uses a monochromatic light source and therefore eliminates the contribution from other wavelengths such as lower wavelength light that is heavily absorbed in the upper layers therefore sealing the upper layers. Advantageously the laser bar diode used allows for the removal of a greater portion of materials, such as organic binder, in the precursor nanomaterial. This is a consequence of the waveform not sealing the upper layers as in the prior art, therefore allowing the laser to penetrate to a greater depth.

A further advantage is the use of steady state or continuous/quasi-continuous wave lasers as it is found that by using a continuous wave with a top hat waveform high energy peaks associated with Xenon lamps are avoided. These peaks in Xenon lamps are found to cause ablation of the precursor material rather than sintering, and therefore the pulsing lamps result in a less efficient transformation of the precursor material than the monochromatic continuous wave used in the present invention. Furthermore, it is found that whilst some substrates are not affected/damaged by the central wavelength of the Xenon lamp, the high energy peaks may damage the substrate. It is also found that high thermal conductivity substrates such as aluminium, silicon and ceramics conduct heat from the area of incident light before sintering can take place. The present invention advantageously overcomes these limitations by using the laser array 14 and modifying the beam with the optical lens or array 16. These advantages are also observed on processing coated plastic layers for example, ITO coated plastic substrates. ITO is known to absorb at certain wavelengths causing structural damage, the use of a monochromatic light source allow for the selection of laser wavelength to optimise the sintering of the nanoparticles whilst limiting or negating any damage to the coating.

In a preferred embodiment the power supplied by the laser bar diode array 14 is controlled by the laser current supply 28. By increasing the Amps supplied to the laser bar diodes the output of the lasers can be varied. The optical array 16 can also affect the intensity by focusing/defocusing the beam and the control of the optical array 16 is performed by the optics controller 30 (described with reference to FIG. 1). In a preferred embodiment both the laser current supply 28 and optics controller 30 are controlled by a central computer 26. The central computer 26 communicates with the laser current supply 28 and the optics controller 30 to selectively engage/disengage the respective components to modify the emitted beam. In use, the user inputs into the computer 26, using known input means such as a keyboard, the substrate 22 material, and the type, width and depth of deposited nanomaterial 24. The computer 26 has a form of writeable memory, or is enabled to access a memory, which comprises a look up table so that the optimal optical configuration and laser power may be selected. As discussed above, by focusing or defocusing the laser beam with the optical array 16 a single diode laser can be used for a number of different materials. From the input the computer 26 also determines the focusing needed for the laser beam, and/or the numbers of diode lasers required in order to produce a beam which extends the width of the substrate. To help maintain the efficiency of the curing process the laser beam preferably extends the width of the deposited material. The computer 26 therefore provides an easily automated system as the control of the system is determined by the input parameters.

Once the appropriate laser wavelength, beam size and power have been selected, the computer 26 configures the laser array 14 and optical array 16 appropriately. The highly tunable nature of the invention, via the ability to use multiple wavelength lasers, the variations of the voltage and current, and the use of lenses allows for an elevated level of control. This control is used to ensure that the material is sintered, as opposed to ablated, and is found to produce metal or semi-metal structures which are of higher purity, and with improved conductivity and adhesion when compared to Xenon lamp systems.

In further embodiments the receptacle further comprises a heat sink 20 and one or more temperature sensors 32. The heat sink allows for the transfer of heat generated by the laser beam(s) to be transferred away from the nanomaterial 24 and substrate 22. As some nanomaterials have a high curing temperature regulation and removal of the excess heat is desirable to prevent overheating which may adversely affect other features, in particular the substrate 22.

As it is preferred that the receptacle 18 hold the substrate flat, the receptacle is a vacuum bed. Preferably, the bed is water cooled to ensure the substrate is maintained at a constant temperature during processing so that the sintering is more uniform.

In a further example of the invention the substrate is heated such that lower laser power is required to complete the sintering process.

In order to prevent excess heat build-up the apparatus 10 advantageously further comprises a temperature sensor 32 which is in communication with the computer 26. The temperature sensor 32 may be a commercially available sensor used in annealing ovens and curing devices. The sensor 32 is in communication with the computer 26 which monitors the temperature of the apparatus 10. In the memory of the central computer 26 there is preferably stored predetermined temperature limits for a given substrate 22 and nanomaterial 24 combination. If the measured temperature approaches the predetermined temperature limits the computer 26 reduces the energy of the laser (through the laser power supply), which subsequently results in a reduction in the temperature of the apparatus 10. In certain embodiments, if the temperature exceeds a critical limit (which is associated with a risk, such as fire) the computer 26 cuts off the laser current supply 28. Therefore, the temperature sensors 32 act as a safety measure, as well as a monitor to ensure optimal curing conditions are maintained. In a preferred embodiment the temperature sensors 32 are used to ensure that the apparatus is kept within an operating temperature of 15° C. to 35° C.

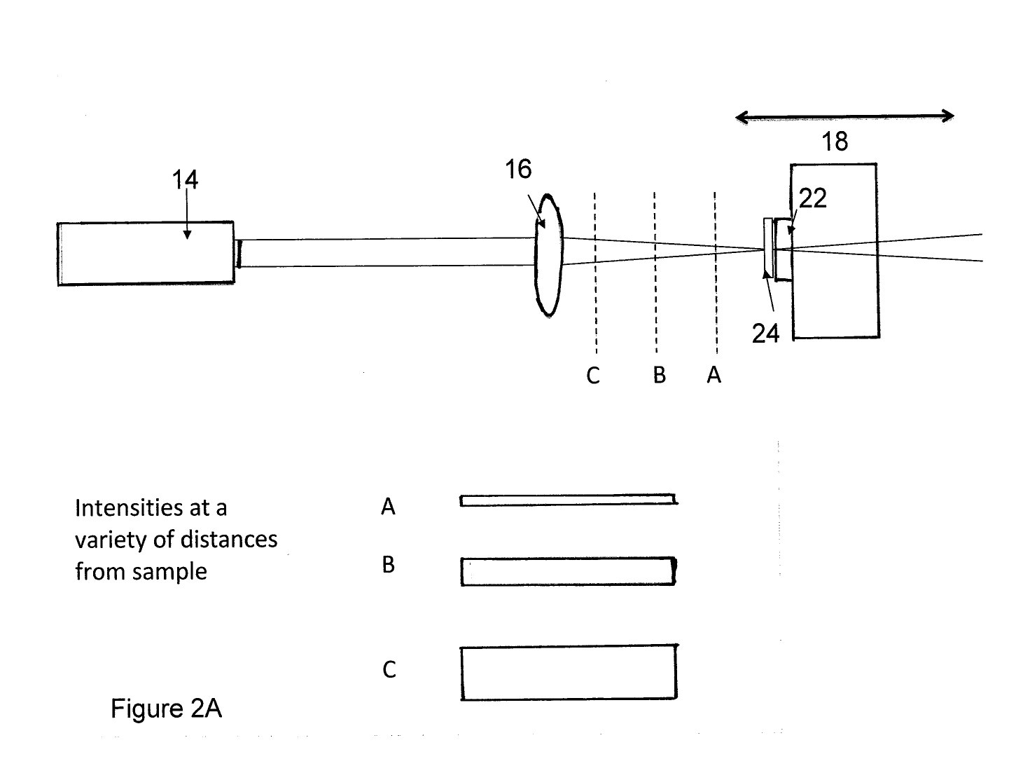

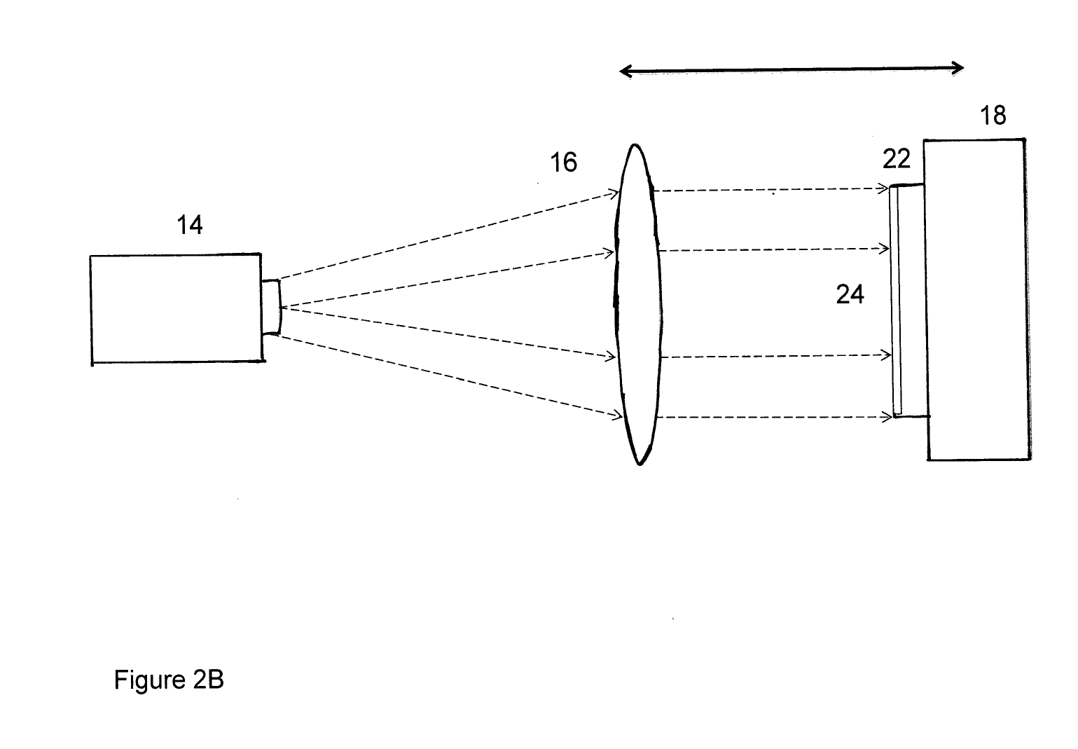

FIGS. 2a and 2b show a schematic representation of the laser and optical arrays 14 and 16 according to an aspect of the invention. There is shown the diode bar laser array 14, optical array 16, receptacle 18, substrate 22, and deposited nanomaterial 24 to be cured.

FIG. 2a is a plan view of the apparatus and FIG. 2b is a top view of FIG. 2a.

In FIG. 2a, the fast axis of a laser beam is shown which extends of the order of a few millimetres. The laser beam emitted from the laser array 14 passes to the optical lens 16 whereupon it is focused. In the embodiment shown, the receptacle 18 is movable, with the direction of movement shown by the arrow in FIG. 2a.

As the receptacle 18 moves towards the optical lens 16 the intensity of the laser beam changes. As shown in FIG. 2a, in order to obtain a beam of maximum intensity the nanomaterial layer 24 is placed at the focal point of the laser array 14, and accordingly, at the position shown in FIG. 2a, the laser beam is at a maximum intensity on the nanomaterial layer 24.

There is also shown in FIG. 2a possible positions A, B, and C of the receptacle 18, represented as dash lines. As the receptacle 18 progresses from positions A to C, the laser beam is more disperse, and accordingly the intensity of the laser beam decreases. Therefore, by the relative movement of the receptacle 18 to the laser array 14 the intensity of the laser beam can be varied according to the requirements of the invention.

In further embodiments, the receptacle 18 is stationary and the optical lens 16 is moved relative to the laser array 14 and receptacle 18, or both the optical lens 16 and receptacle 18 are moveable relative to each other. Accordingly, the focal point of the laser beam through a given lens is variable and the laser intensity on the sample is therefore variable.

Of importance when moving the array 14 and receptacle 18 is the focal depth to ensure the laser curtain is at the appropriate focus point on the substrate. The apparatus may include a height sensor (not shown). By sensing the height of the substrate 22 relative to the final lens, automatic adjustments in this height can be achieved by adjusting the separation between the laser array 14 and receptacle 18 ensuring the same focus is achieved. Therefore as well as adjusting the intensity of the laser beam emitted by the array 14, the apparatus is configured to ensure that the appropriate focus point is emitted onto the substrate 24.

FIG. 2b shows a plan view of the apparatus shown in FIG. 2a. The optical path of the laser array 14 shown in FIG. 2b represents the slow axis of the laser. As shown in FIG. 2b, whilst the receptacle 18 moves relative to the optical lens 16 the size of the laser beam in the slow axis remains unchanged and accordingly the laser beam remains incident upon the entire width of the deposited nanomaterial layers 24 regardless of the relative position of the laser array 14 and optical lens 16. Therefore, whilst the intensity of the laser beam varies whilst the receptacle 18 is moved relative to the optical lens 16 (as shown in FIG. 2a) the coverage of the laser beam remains unchanged.

Advantageously by varying the intensity of the laser light by changing the relative separation of the receptacle 18, optical lens 16, and laser array 14, the system becomes much less dependent on the initial set-up that if the optical lens 16 and receptacle 18 were not moveable relative to the laser array 14. Therefore, initial set up costs associated with the apparatus are greatly reduced as the apparatus is less sensitive to the initial calibration of the apparatus.

Furthermore, the ability to move the sample or lens, allows for the curing of 3D shapes, by curing a printed 3D image in a single step. As the laser scans across the substrate to cure the deposited material the depth of the deposition changes according to the 3D feature. By inputting to a central computer that is configured to control the apparatus (discussed in detail with reference to FIG. 4) the size, shape and depth of the deposited material a scanning pattern for the 3D printed shape can be determined. As the laser array 14 scans across the deposited material, thereby curing the material, by changing the relative separations of the optical lens 16 and receptacle 18 as the laser scans across the sample, changes in the depth of the deposited material can be accounted for. In an embodiment, the intensity of the laser beam can be varied as the laser array 14 scans across the sample, with a higher intensity beam used for thicker depositions of material. In another embodiment, the system is configured so that the focal point of the laser beam is always incident on the top surface of the deposited material and accordingly either the position focal point is varied as the laser array 14 scans across the deposited material or the focal point is fixed and the position of the receptacle 18 changes.

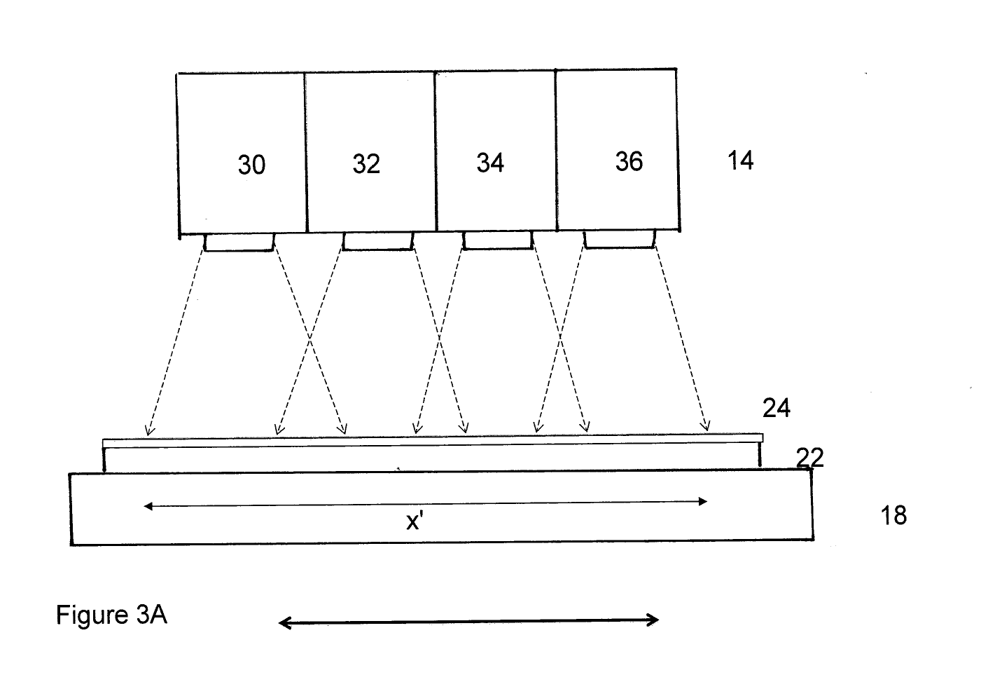

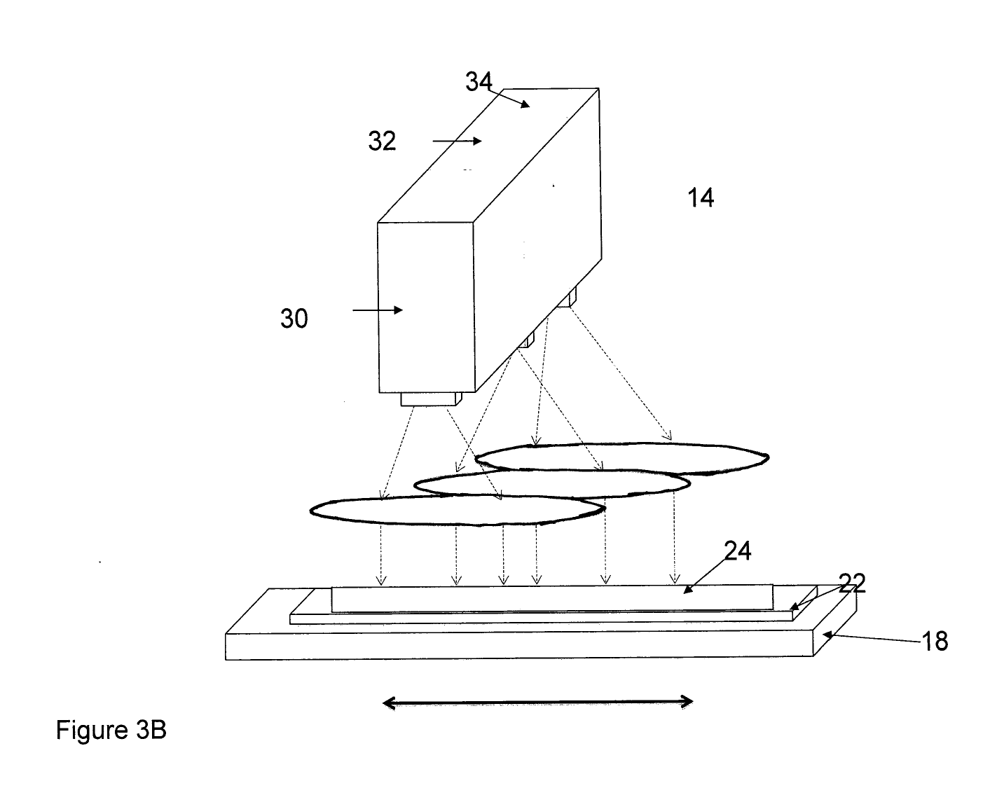

FIGS. 3a and 3b show various configurations of the diode bar laser array 14 which can be used according to an aspect of the invention.

There is shown the diode bar laser array 14 comprising a plurality of diode bar lasers 31, 33, 34, and 36. There is also shown the nanomaterial layer 24, substrate 22 and receptacle 18. The arrow in FIGS. 3a and 3b represents the direction of movement of the receptacle 18 relative to the laser array 14.

In FIG. 3a the laser array 14 is configured in a “horizontal” multiple laser array arrangement. In such an arrangement, the laser array 14 comprises a plurality of diode lasers arranged in series. The arrangement of the laser bar diodes 31, 33, 34, and 36 overlap, thereby providing a laser beam that extends in the X direction. The total effective beam front is shown in FIG. 3 as X′. As is shown in FIG. 3a the use of multiple lasers 30 to 36 in the laser bar diode array 14 allow for large scale coverage of the nanomaterial 24 as deposited on the substrate 22. In an industrial environment, the laser array 14 therefore can cover an extended area in the X direction.

FIG. 3b shows a “vertical” arrangement of the laser array 14. In such an arrangement, the individual laser bar diodes 31, 33, 34, and 36 cover substantially the same area in the X direction and extends in the Y direction. Such an arrangement can be used to simultaneously cure several samples at the same time.

Furthermore, where the receptacle 18 (and therefore sample) moves in the Y direction the use of multiple different frequency laser bar diodes provides further configurability to the system. The first bar diode laser 31 can sinter the material whereas the subsequent lasers 34 and 36 are used to dry the deposited material. Therefore, greater control can be given to the laser array 14 and apparatus 10.

Advantageously, in such an arrangement described with respect to FIG. 3 with each laser bar diode array having the same or differing wavelength lasers and placed adjacent in a process sequence. The curing process can thus be performed using said sequence of bar diode arrays at varying power densities, and spaced in such a way, as to create differing sintering effects to advantageously cure the coating material in a controlled manner. For example, a long wavelength bar diode laser array may first be employed to cure material at depth in a coating. The same partially cured coating can be exposed to a further second, third, etc., laser bar diode at lower wavelengths. The lower wavelengths selected to preferentially cure the material at a shallower depths. In further embodiments multiple layers of material with varying degrees of sintering throughout their depth of a coating could be imparted using such selective wavelengths such that multiple interfaces and characteristics may result. Therefore, the present system provides a much greater level of control in terms of depth and typing sintering as well as ensuring that the substrate remains undamaged.

FIG. 4 shows a flowchart of the process of curing nanomaterials according to an aspect of the invention.

There is shown the step of inputting the nanomaterial and substrate type at step S102: inputting the size of the substrate at step S104: determining the optical and laser arrays to be used at step S106: powering the laser at step S108: checking the temperature at step S110: determining whether the temperature is within an acceptable limit at step S112: reducing the power supplied to the laser array at step S114: and ending the process at step S116.

At step S102 the user of the invention inputs via an interface such as a keyboard, the nanomaterial that is to be cured and the material of the substrate upon which the nanomaterial is deposited. At step S104 the user also inputs the size of the substrate. In a preferred embodiment the nanomaterial extends the width of the substrate. If the deposited material is placed in a 3D shape, the user inputs the shape and depth of the deposit of nanomaterial to be cured. Preferably, the user at this stage inputs the thickness of the deposited nanomaterial. Therefore, at stages S102 and S104 the user has initialised the invention, and has identified to the central computer the types of material used and the thickness of the deposited nanomaterial.

At step S106, the central computer determines the optimal laser configuration and optical array configuration to cure the identified nanomaterial. In particular, the choice of lenses and/or apertures used in the optical array are determined to ensure the laser emitted by the laser array covers the entire width of the deposited material and that the wavelength and intensity of the laser beam is sufficient to cure the entire depth of the deposited nanomaterial but not adversely affect the substrate.

The ability to configure the apparatus at steps S102 and S104 and for the system to calculate the optimal configurations at step S106 is particularly beneficial in 3D printing. By enabling the user to define the shape and depth of the printed material the laser beam can be configured to allow for the curing of the material in a single step. In particular the receptacle and/or lens can be moved according to the thickness of the material in order to ensure a single stage curing of a 3D printed shape.

At step S108, the computer determines the optimal laser strength and powers the lasers. As discussed above, the intensity of the laser is dependent on the amount of the material deposited as well as the bulk curing temperature of the materials. Accordingly, the power of the laser beam selected at step S108 is chosen so as to optimally cure the deposited nanomaterials both in terms of the material selected and the amount of material deposited.

The incident laser will result in the heating of the apparatus. In order to ensure that the apparatus functions within a safe limit, and to further ensure that the apparatus does not adversely affect the substrates, the temperature of the apparatus is measured at step S110 and altered if necessary at step S112. The process described with respect to steps S110, S112 and S114 preferably occurs once a second. The central computer comprises a database which contains a series of predetermined values which represent an acceptable temperature limit for a given nanomaterial and substrate combination. The acceptable limits are based on the likelihood of damage to the substrate and/or nanomaterial based on the measured temperature, and also preferably contain a safety limit which represents the risk of unacceptably high temperature which may lead to an event such as a fire. The measured temperature is checked against these predetermined limits at step S110.

At step S112 the computer determines whether the measured temperature is within an acceptable limit. If the computer determines that the measured temperature is indeed acceptable the process returns to step S110. Accordingly, the process therefore repeats at one second intervals to ensure that any rapid temperature rises are identified by the central computer. If the measured temperature is deemed to be unacceptable or approaching an unacceptable limit at step S112 the process moves to step S114 to reduce the measured temperature. At step S114 the central computer reduces the power supply to the laser current supply thereby reducing the output intensity of the laser beam. Advantageously, as the reaction of the nanomaterial from the laser is governed by quantum effects, a reduction in the intensity of the laser will still result in the curing of the nanomaterial whilst reducing the temperature of the apparatus. If the temperature is approaching the safety limits at step S114, the computer disengages all power supplied to the laser current supply thereby turning off all curing lasers.

At step S116 the process ends, wherein all nanomaterials have been successful cured. Therefore, the invention provides a highly tuneable system which can be adjusted according to the conditions of the system. In particular, the invention can be configured according to the choice of deposited material and substrate upon which it is placed. Beneficially, the ability to adjust the frequency and/or intensity of the laser, emitted at a steady state as a continuous or quasi-continuous wave ensures that the entirety of the deposited material is cured and the substrate is not damaged.

The method and apparatus described therefore allows for a high speed curing of nanoparticle inks and pastes. The system is cost effective and highly scalable allowing for low cost and high production of cured structures, such as printed electronic conductive surfaces.

Advantageously, the use of the laser bar diode array allows for thick layer penetration. It is found that layers of over 30 microns in depth can be fully cured thereby producing highly conductive surfaces. Furthermore, the curing times for the thick deposits are reduced compared to known systems and it is found that deposited nanoparticle inks and pastes can be cured in timescales of the order of milliseconds.

The laser bar diode array is also highly tuneable in terms of beam width, intensity, and power output. The laser emitted to cure the deposited nanoparticle material can therefore be selected, and modified during the curing process, to maximise the efficiency of the system depending on the substrate chosen and the ink or paste used. Advantageously, due to the continuous wave nature of the lasers used the parameters of the lasers used are selected to minimise substrate heating and prevent damage to the substrate.

1. An apparatus for curing of nanoparticle material, the apparatus comprising:
a receptacle for receiving a substrate upon which a layer of the nanoparticle material has been deposited, the nanoparticle material comprising a nanoparticle ink or paste; and
a laser bar diode array comprising a first diode bar laser, the array configured to emit a laser beam as a steady state wave which cures the deposited layer of nanoparticle material.

2. An apparatus of claim 1, wherein the laser beam extends the width of the deposited layer of the nanoparticle material.

3. An apparatus of claim 1, wherein the apparatus further comprises an optical array placeable between the laser bar diode array and the substrate and configured to modify the wavefront emitted by the laser bar diode array.

4. An apparatus of claim 3, wherein the optical array is configured to focus or diffuse the emitted laser beam.

5. An apparatus of claim 3, wherein the optical array comprises a first aperture configured to produce a “top-hat” type wavefront.

6. An apparatus of claim 3, wherein the optical array comprises a first lens.

7. An apparatus of claim 1, further comprising one or more further diode bar lasers.

8. An apparatus of claim 7, wherein the plurality of diode bar lasers are placed in series.

9. An apparatus of claim 7, wherein two or more of the diode bar lasers are configured to emit at different frequencies.

10. An apparatus of claim 9, wherein a second diode bar laser is configured to dry or “soft” sinter the deposited material.

11. An apparatus of claim 1, further comprising a processor configured to control the apparatus.

12. An apparatus of claim 11, wherein the processor is part of a controller unit configured to selectively engage the one or more diode bar lasers.

13. An apparatus of claim 11, wherein the processor is configured to control the intensity of the emitted laser beam.

14. An apparatus of claim 12, wherein the controller unit further controls the current supplied to the laser bar diode array.

15. An apparatus of claim 11, further comprising a sensor configured to measure the temperature of the apparatus.

16. An apparatus of claim 15, wherein the sensor is in communication with the processor and the processor is further configured to maintain the temperature below a predetermined value by selectively adjusting the intensity of the laser beam.

17. An apparatus of claim 1, further comprising a computer configured to receive information regarding the deposited layer of the nanoparticle material and/or substrate.

18. An apparatus of claim 17, wherein the computer is further configured to determine the relative separation between the receptacle, optical array, and laser bar diode array based on the received information.

19. An apparatus of claim 1, further comprising a heat sink.

20. An apparatus of claim 1, wherein the receptacle and laser bar diode array are moveable relative to each other.

21. An apparatus of claim 1, wherein the laser bar diode array is configured to emit at a frequency which is transparent to the substrate.

22. An apparatus of claim 1, further comprising a source of inert gas to provide an inert atmosphere in which the nanoparticles are cured.

23. An apparatus of claim 1, further comprising one or more further laser bar diode arrays.

24. An apparatus of claim 1, further comprising a chamber in which the receptacle is placed and configured to reduce reflections of the laser light.

25. An apparatus of claim 1, wherein the wavelength emitted by the laser bar diode is such that the substrate is transparent.

26. An apparatus of claim 1, further comprising a heating element for heating the substrate.

27. An apparatus of claim 1, wherein the receptacle is a vacuum bed.

28. An apparatus of claim 27, wherein the vacuum bed is water cooled.

29. An apparatus of claim 7, wherein a first laser is configured to emit at a lower power than a second laser, the first laser thereby soft sintering the deposited layer of nanoparticle material.

30. An apparatus of claim 1, wherein the steady state laser is a continuous or quasi-continuous laser.
